(19) United States
(12) Patent Application Publication
(10) Pub. No.: US 2012/0080946 A1
(43) Pub. Date: Apr. 5, 2012

(54) ELECTRONIC DEVICE AND METHOD FOR MANAGING CURRENT OF THE ELECTRONIC DEVICE

(75) Inventor: JIAN PENG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/095,882

(22) Filed: Apr. 28, 2011

(30) Foreign Application Priority Data
Sep. 30, 2010 (CN) 201010298251.4

(51) Int. Cl. H02J 4/00

(52) U.S. Cl. 307/31

(57) ABSTRACT

A method for managing current of an electronic device initializes a control signal of a baseboard management controller (BMC) of the electronic device to be a low level before the electronic device is powered on, maintains the control signal under a low-level status for a specified time upon the condition that a power on signal of the electronic device is received, and rotates the electronic fan with a low current and a low speed. The method further sets the control signal to be a high level when the specified time elapses to rotate the electronic fan with a normal current and a normal speed, and sets the control signal to be the low level upon the condition that a power off signal of the electronic device is received.

### BACKGROUND

1. Technical Field

Embodiments of the present disclosure relate to power management technology, and particularly to an electronic device and method for managing current of the electronic device.

2. Description of Related Art

Servers include a plurality of hardware devices, such as processors, hard disks, and electronic fans. The momentary current of each kind of the hardware devices may reach a peak value when the server is powered on, the normal current of each type of the hardware devices is reduced rapidly when the server is under a normal operation condition. For example, the normal current of an electronic fan is a fifth of the peak value of the momentary current of the electronic fan. Thus, if a total current supplied by a server is less than a sum of the peak value of the momentary current of each kind of hardware devices, the server cannot be turned on successfully. To resolve this problem, a high power supply should be installed in the server. However, a cost of the high power supply is expensive. Therefore, a more efficient method for managing the current of an electronic device is desired.

### BRIEF DESCRIPTION OF THE DRAWINGS

FIG. 1 is a block diagram of one embodiment of an electronic device.

FIG. 2 is a block diagram of one embodiment of a current management system in the electronic device.

FIG. 3 is a flowchart of one embodiment of a method for managing current of the electronic device.

### DETAILED DESCRIPTION

All of the processes described below may be embodied in, and fully automated via, functional code modules executed by one or more general purpose electronic devices or processors. The code modules may be stored in any type of non-transitory readable medium or other storage device. Some or all of the methods may alternatively be embodied in specialized hardware. Depending on the embodiment, the non-transitory readable medium may be a hard disk drive, a compact disc, a digital video disc, a tape drive or other suitable storage medium.

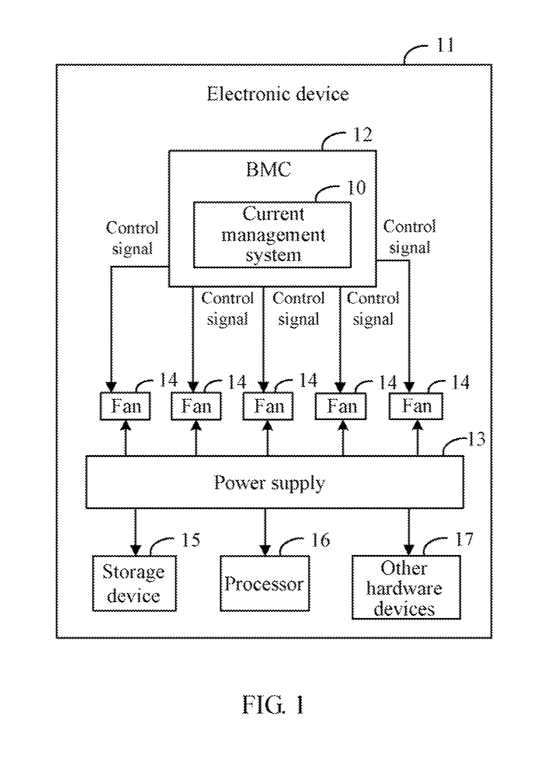

FIG. 1 is a block diagram of one embodiment of an electronic device 11. The electronic device 11 includes a baseboard management controller (BMC) 12, a power supply 13, one or more electronic fans 14 (short for “Fan” in FIG. 1), a storage device 15, at least one processor 16, and other hardware devices 17 (e.g., memory card). The power supply 13 provides power to the electronic fans 14, the storage device 15, the processor 16, and the other hardware devices 17. The BMC 12 generates a plurality of control signals, and transmits each control signal to an input port of a pulse width modulation (PWM) signal of each electronic fan 14 to control a level of the electronic fan 14. In one embodiment, the control signal is a general purpose input/output (GPIO) signal, and a level of the GPIO signal is determined by a value of a data register of the GPIO signal of the BMC 12. For example, if the value of the data register of the GPIO signal equals logic 0, the GPIO signal is set to be a low level. If the value of the data register of the GPIO signal equals logic 1, the GPIO signal is set to be a high level.

The BMC 12 includes a current management system 10. The current management system 10 may be used to control each electronic fan 14 rotating with a low current and a low speed to reduce a peak value of the current of the electronic device 11 when the electronic device 11 is powered on. For example, as shown in FIG. 1, supposing that the server 11 includes five electronic fans 14, the peak value of the current of each of the five electronic fans 14 is 1.5 A, and a sum of the peak value of the current of the storage device 15, the processor 16, and the other hardware devices 17 of the server 11 is 14A. Thus, a total current needed by the electronic device 11 is (1.5*5+14)=21.5A. If the maximum current supplied by the power supply 13 is only 19A, the electronic device 11 cannot be turned on successfully. In one embodiment, the electronic device 11 may be a server, the storage device 15 may be a non-volatile storage, such as a field replacement unit (FRU) storage area.

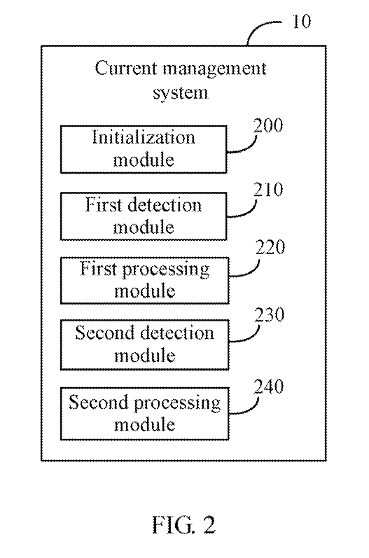

FIG. 2 is a block diagram of one embodiment of the current management system 10 in the electronic device 11. In one embodiment, the current management system 10 may include one or more modules, for example, an initialization module 200, a first detection module 210, a first processing module 220, a second detection module 230, and a second processing module 240. The one or more modules 200-240 may comprise computerized code in the form of one or more programs that are stored in the storage device 15 (or memory). The computerized code includes instructions that are executed by the at least one processor 16 to provide functions for the one or more modules 200-240.

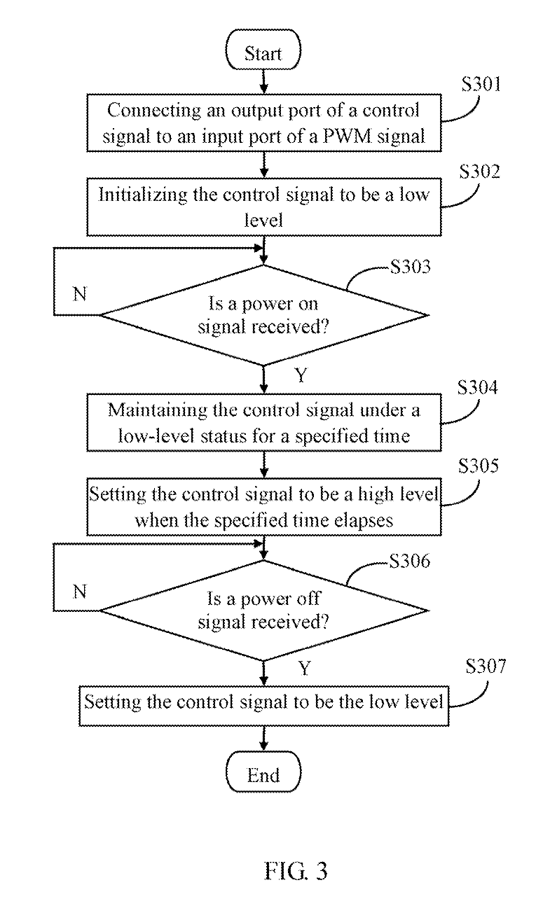

FIG. 3 is a flowchart of one embodiment of a method for managing the current of the electronic device 11. Depending on the embodiment, additional blocks may be added, others removed, and the ordering of the blocks may be changed.

In block S301, an output port of each control signal of the BMC 12 is connected to the input port of the PWM signal of each electronic fan 14.

In block S302, the initialization module 200 initializes each control signal of the BMC 12 of the electronic device 11 to be a low level before the electronic device 11 is powered on. In one embodiment, the initialization module 200 initializes each control signal of the BMC 12 to be the low level by assigning a value “0” to the data register of the GPIO signal of the BMC 12.

In block S303, the first detection module 210 determines if a power on signal of the electronic device 11 is received. If the power on signal of the electronic device 11 is received, the procedure goes to block S304. If the power on signal of the electronic device 11 is not received, block S303 is repeated.

In block S304, the first processing module 220 maintains each control signal under a low-level status for a specified time, and controls each electronic fan 14 rotating with a low current (e.g., 0.2 A) and a low speed to reduce a peak value of the current in the electronic device 11. In one embodiment, the specified time is greater than five seconds and less than ten seconds.

In block S305, the first processing module 220 sets each control signal of the

BMC 12 to be a high level when the specified time elapses, and rotates each electronic fan 14 with a normal current (e.g., 1.5 A) and a normal speed. In one embodiment, the first processing module 220 sets each control signal of the BMC 12 to be the high level by assigning the value “1” to the data register of the GPIO signal of the BMC 12.

In block 5306, the second detection module 230 determines if a power off signal of the electronic device 11 is received. If the power off signal of the electronic device 11 is received, the procedure goes to block S307. If the power off signal of the electronic device 11 is not received, block S306 is repeated.

In block S307, the second processing module 240 sets each control signal of the BMC 12 to be the low level. As mentioned above, the second processing module 240 sets each control signal of the BMC 12 to be the low level by assigning the value “0” to the data register of the GPIO signal of the BMC 12.

As mentioned above, because the current of each of the five electronic fans 14 is reduced to 0.2 A when the electronic device 11 is powered on, and the sum of the peak value of the current of the storage device 15, the processor 16, and the other hardware devices 17 of the electronic device 11 keeps 14A. Thus, the total current needed by the electronic device 11 is reduced to (0.2*5+14)=15 A, and the electronic device 11 is turned on successfully.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A method for managing current of an electronic device, the method comprising:
initializing a control signal of a baseboard management controller (BMC) of the electronic device to be a low level before the electronic device is powered on, the control signal being transmitted from the BMC to an input port of a pulse width modulation (PWM) signal of a electronic fan of the electronic device;
determining if a power on signal of the electronic device is received;
maintaining the control signal under a low-level status for a specified time upon the condition that the power on signal of the electronic device is received, and rotating the electronic fan with a low current and a low speed to reduce a peak value of the current of the electronic device;
setting the control signal to be a high level when the specified time elapses, and rotating the electronic fan with a normal current and a normal speed;
determining if a power off signal of the electronic device is received; and
setting the control signal to be the low level upon the condition that the power off signal of the electronic device is received.

2. The method according to claim 1, wherein the control signal is a general purpose input/output (GPIO) signal.

3. The method according to claim 2, wherein a level of the GPIO signal is determined by a value of a data register of the GPIO signal.

4. The method according to claim 3, wherein the step of initializing a control signal of a baseboard management controller (BMC) of the electronic device to be a low level by assigning a value “0” to a data register of the GPIO signal of the BMC.

5. The method according to claim 3, wherein the step of setting the control signal to be a high level by assigning a value “1” to a data register of the GPIO signal of the BMC.

6. The method according to claim 1, wherein the specified time is greater than five seconds and less than ten seconds.

7. An electronic device, comprising:
a storage device;
a baseboard management controller (BMC);
at least one processor; and
one or more modules that are stored in the storage device and are executed by the at least one processor, the one or more modules comprising instructions:
to initialize a control signal of the BMC to be a low level before the electronic device is powered on, the control signal being transmitted from the BMC to an input port of a pulse width modulation (PWM) signal of a electronic fan of the electronic device;
to determine if a power on signal of the electronic device is received;
to maintain the control signal under a low-level status for a specified time upon the condition that the power on signal of the electronic device is received, and rotate the electronic fan with a low current and a low speed to reduce a peak value of the current of the electronic device;
to set the control signal to be a high level when the specified time elapses, and rotate the electronic fan with a normal current and a normal speed;
to determine if a power off signal of the electronic device is received; and
to set the control signal to be the low level upon the condition that the power off signal of the electronic device is received.

8. The electronic device according to claim 7, wherein the control signal is a general purpose input/output (GPIO) signal.

9. The electronic device according to claim 8, wherein a level of the GPIO signal is determined by a value of a data register of the GPIO signal.

10. The electronic device according to claim 9, wherein the instruction to initialize a control signal of a baseboard management controller (BMC) of the electronic device to be a low level by assigning a value “0” to a data register of the GPIO signal of the BMC.

11. The electronic device according to claim 9, wherein the instruction to set the control signal to be a high level by assigning a value “1” to a data register of the GPIO signal of the BMC.

12. The electronic device according to claim 7, wherein the specified time is greater than five seconds and less than ten seconds.

13. A non-transitory storage medium having stored thereon instructions that, when executed by a processor of an electronic device, causes the processor to perform a method for managing current of the electronic device, the method comprising:
initializing a control signal of a baseboard management controller (BMC) of the electronic device to be a low level before the electronic device is powered on, the control signal being transmitted from the BMC to an input port of a pulse width modulation (PWM) signal of a electronic fan of the electronic device;
determining if a power on signal of the electronic device is received;
maintaining the control signal under a low-level status for a specified time upon the condition that the power on signal of the electronic device is received, and rotating the electronic fan with a low current and a low speed to reduce a peak value of the current of the electronic device;
setting the control signal to be a high level when the specified time elapses, and rotating the electronic fan with a normal current and a normal speed;
determining if a power off signal of the electronic device is received; and
setting the control signal to be the low level upon the condition that the power off signal of the electronic device is received.

14. The non-transitory storage medium according to claim 13, wherein the control signal is a general purpose input/output (GPIO) signal.

15. The non-transitory storage medium according to claim 14, wherein a level of the GPIO signal is determined by a value of a data register of the GPIO signal.

16. The non-transitory storage medium according to claim 15, wherein the step of initializing a control signal of a baseboard management controller (BMC) of the electronic device to be a low level by assigning a value “0” to a data register of the GPIO signal of the BMC.

17. The non-transitory storage medium according to claim 15, wherein the step of setting the control signal to be a high level by assigning a value “1” to a data register of the GPIO signal of the BMC.

18. The non-transitory storage medium according to claim 13, wherein the specified time is greater than five seconds and less than ten seconds.

19. The non-transitory storage medium according to claim 13, wherein the medium is selected from the group consisting of a hard disk drive, a compact disc, a digital video disc, and a tape drive.
